(19) United States
(12) Patent Application Publication
(10) Pub. No.: US 2025/0118321 A1
(43) Pub. Date: Apr. 10, 2025

(54) AUDIO FILTER SYSTEM FOR A VEHICLE

(71) Applicant: GM Global Technology Operations LLC, Detroit, MI (US)

(72) Inventors: Moshe Levy Israel, Ashdod (IL); Elior Hadad, Ness-Ziona (IL)

(73) Assignee: GM Global Technology Operations LLC, Detroit, MI (US)

(21) Appl. No.: 18/482,978

(22) Filed: Oct. 9, 2023

(51) Int. Cl. G10L 21/0232; G10L 21/0208; G10L 21/0216; G10L 21/034; G10L 21/0364; G10L 25/18; G10L 25/21

(52) U.S. Cl. CPC G10L 21/0232; G10L 21/034; G10L 21/0364; G10L 25/18; G10L 25/21; G10L 2021/02087; G10L 2021/02166

(57) ABSTRACT

A computer-implemented method executed by data processing hardware that causes the data processing hardware to perform operations to design an audio filter. The operations include receiving multiple audio signals from a sensor array, the multiple audio signals including a target audio signal and interference audio signals and leveraging the interference audio signals. The multiple audio signals are processed using short-time Fourier transform (STFT) for each of the multiple audio signals. The operations also include designing the audio filter using the determined prior-SNR and enhancing the target audio signal using the leveraged interference audio signals and the designed audio filter and attenuating the interference audio signals.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to an audio filter system for a vehicle.

Interference cancellation and source separation tasks are required for both telecommunication and virtual assistance applications to enhance the desired speaker and cancel interferences, such as undesired speakers. Typically, when a microphone array is installed in a vehicle, interference cancellation is obtained by applying spatial filters, such as beamformers. Beamformers typically yield high white noise gain, which decreases noise reduction performance. As a result, residual interference signals may still exist in the beamformer output, resulting in degradation of the application layer performance.

### SUMMARY

In some aspects, a computer-implemented method is executed by data processing hardware that causes the data processing hardware to perform operations to design an audio filter. The operations include receiving, from a sensor array, multiple audio signals including a target audio signal and interference audio signals. The multiple audio signals are processed using short-time Fourier transform (STFT), and an output vector is generated for each of the multiple audio signals via a beamformer. The operations further include estimating a noise variance for each of the multiple audio signals and extracting a speech energy for a respective speaker corresponding to each of the multiple audio signals using the generated output vector from the beamformer. A prior-signal-to-noise ratio (prior-SNR) is determined using the generated output vectors, the estimated noise variance, and the speech energy for each of the multiple audio signals, and a gain value is determined based on the prior-SNR.

In some examples, the target audio signal may be enhanced using the designed audio filter and the interference audio signals may be attenuated. Optionally, the multiple audio signals may be processed using STFT including determining a timeframe index and a frequency bin index. In some configurations, generating the output vector for each of the multiple audio signals via the beamformer may include providing a number of speakers and generating dimensions for the output vector based on the provided number of speakers. The prior-SNR may be determined by calculating an individual prior-SNR for each of the multiple audio signals and estimating the prior-SNR as a joint prior-SNR of each individual prior-SNR. In some examples, estimating the noise variance for each of the multiple audio signals may include expressing each noise variance as a respective linear equation for each generated output vector from the beamformer, and extracting the speech energy for the respective speaker may include determining the speech energy using the respective linear equation for each generated output vector from the beamformer.

In some aspects, an audio filter system for a vehicle includes data processing hardware and memory hardware. The memory hardware is in communication with the data processing hardware and stores instructions that when executed on the data processing hardware cause the data processing hardware to perform operations to design an audio filter. The operations include receiving multiple audio signals from a sensor array, the multiple audio signals including a target audio signal and interference audio signals. The interference audio signals are leveraged, and a prior-signal-to-noise ratio (prior-SNR) is determined for each of the multiple audio signals. The audio filter is designed using the determined prior-SNR, and the target audio signal is enhanced using the leveraged interference audio signals and the designed audio filter and the interference signals are attenuated using the designed audio filter.

In some examples, the operations may include processing the multiple audio signals using short-time Fourier transform (STFT) and generating an output vector for each of the multiple audio signals via a beamformer. The operation of processing the multiple audio signals using STFT may include determining a timeframe index and a frequency bin index. Optionally, the operation of generating the output vector for each of the multiple audio signals via the beamformer may include providing a number of speakers and generating dimensions for the output vector based on the provided number of speakers. In some examples, determining the prior-SNR may include calculating an individual prior-SNR for each of the multiple audio signals and estimating the prior-SNR as a joint prior-SNR of each individual prior-SNR. In other examples, the operations may also include estimating a noise vector for each of the multiple audio signals and extracting a speech energy for a respective speaker corresponding to each of the multiple audio signals using the estimated noise vector. The operation of estimating the noise vector may include estimating each noise vector by a respective linear equation, and the operation of extracting the speech energy for the respective speaker may include determining the speech energy using the respective linear equation for each noise vector.

In yet other aspects, a computer-implemented method executed by data processing hardware that causes the data processing hardware to perform operations to design an audio filter is provided. The operations include receiving multiple audio signals from a sensor array, the multiple audio signals including a target audio signal and interference audio signals and leveraging the interference audio signals. The multiple audio signals are processed using short-time Fourier transform (STFT) for each of the multiple audio signals. The operations also include designing the audio filter using the determined prior-SNR and enhancing the target audio signal using the leveraged interference audio signals and the designed audio filter and attenuating the interference audio signals.

In some examples, the operations may include processing the multiple audio signals using short-time Fourier transform (STFT) and generating an output vector for each of the multiple audio signals via a beamformer. The operation of processing the multiple audio signals using STFT may include determining a timeframe index and a frequency bin index. Optionally, the operation of generating the output vector for each of the multiple audio signals via the beamformer may include identifying a number of speakers and generating dimensions for the output vector based on the identified number of speakers. In some examples, determining the prior-SNR may include calculating an individual prior-SNR for each of the multiple audio signals and estimating the prior-SNR as a joint prior-SNR of each individual prior-SNR. In other examples, the operations may also include estimating a noise vector for each of the multiple audio signals and extracting a speech energy for a respective speaker corresponding to each of the multiple audio signals using a respective linear equation for each generated output vector. The operation of estimating the noise variance may include estimating each noise variance by the respective linear equation, and the operation of extracting the speech energy for the respective speaker may include determining the speech energy using the respective linear equation for each generated output vector from the beamformer.

### BRIEF DESCRIPTION OF THE DRAWINGS

The drawings described herein are for illustrative purposes only of selected configurations and are not intended to limit the scope of the present disclosure.

FIG. 1 is a schematic view of a vehicle with an audio filter system according to the present disclosure;

FIG. 2 is a partial perspective view of an interior cabin of a vehicle with a sensor array according to the present disclosure;

FIG. 3 is an example graph of a RMSE (root mean square error) of the prior-signal-to-noise-ratio (prior-SNR) of a desired source as a function of SNR measured at an input of an audio filter system according to the present disclosure;

FIG. 4 is a functional block diagram of a vehicle controller including an audio filter system according to the present disclosure;

FIG. 5A is an example schematic of a plurality of zones of an audio filter system according to the present disclosure;

FIG. 5B is an example schematic of the audio filter system of FIG. 5A filtering a plurality of audio signals from each of the plurality of zones according to the present disclosure; and

FIG. 6 is an example flow diagram for an audio filter system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

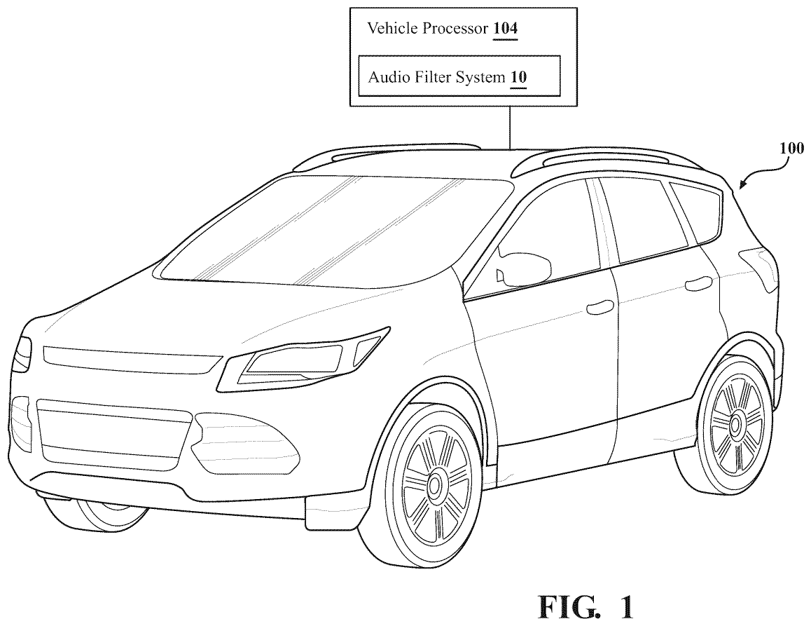

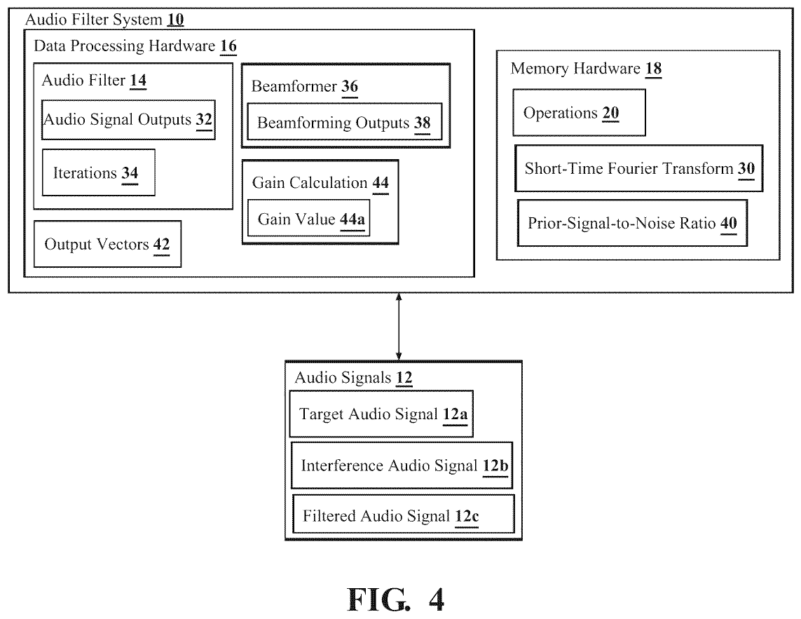

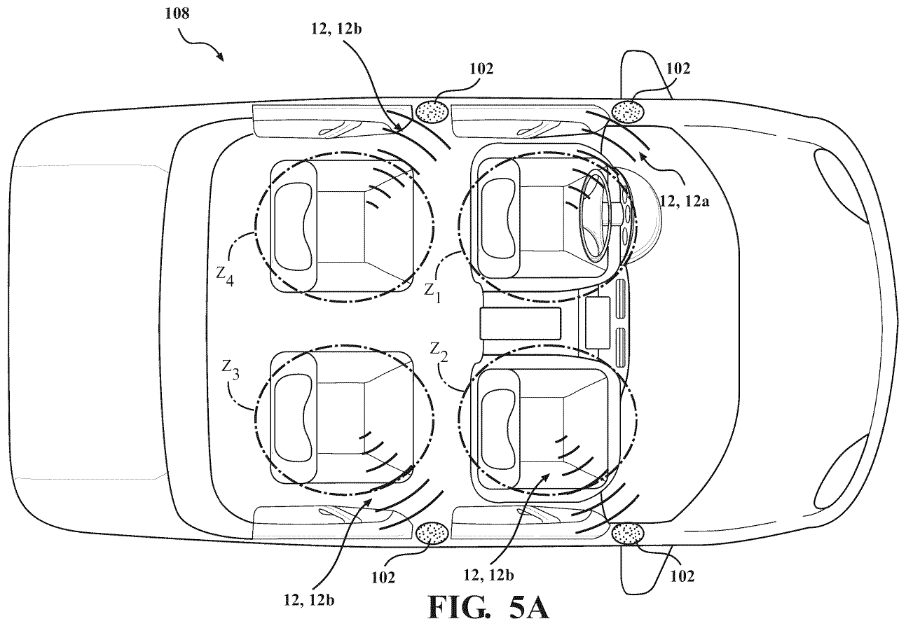

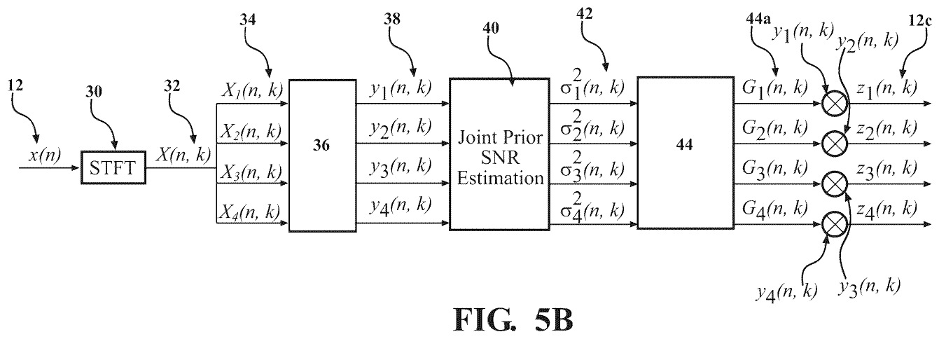

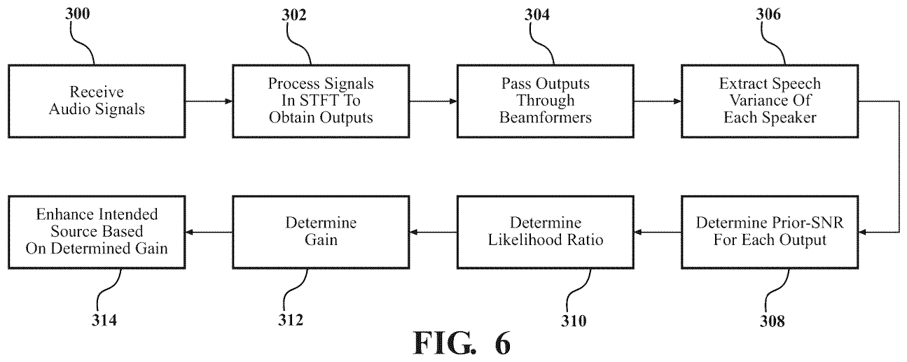

Referring to FIGS. 1-6, an audio filter system 10 may be incorporated in a vehicle 100. In some examples, the audio filter system 10 may be incorporated into any practicable location within the vehicle 100 where audio filtration may be advantageous. For example, the audio filter system 10 may be incorporated into both vehicle and non-vehicle audio capture settings. The audio filter system 10 is described herein with respect to the vehicle 100 for purposes of exemplary functional explanation. However, the audio filter system 10 may be utilized in non-vehicle examples. The audio filter system 10 is configured to divide the vehicle 100 into a plurality of spatial audio zones Z₁-Z₄ (FIG. 5A) including, but not limited to, a driver zone Z₁, a front passenger zone Z₂, a right rear passenger zone Z₃, and a left rear passenger zone Z₄. As described in more detail below, the audio filter system 10 is configured to utilize audio signals 12 received from each respective spatial audio zone Z₁-Z₄ to enhance a target audio signal 12a by leveraging interference audio signals 12b. The interference audio signals 12b, as mentioned below, may be generated by speakers 106 within the vehicle 100. Each of the audio signals 12 is utilized to design an audio filter 14 of the audio filter system 10 based on a position of a speaker or speakers within the vehicle 100 by leveraging the audio signals 12 from each respective spatial audio zone Z₁-Z₄.

The audio filter system 10 is configured to estimate a target speaker 106a based on the audio signals 12. The audio filter system 10 may thus identify the target audio signal 12a among the interference signals 12b. As described herein, the audio filter system 10 is configured to leverage the knowledge of the target audio signal 12a as compared to the interference audio signals 12b to specifically design the audio filter 14 to enhance only the target audio signal 12a by utilizing data from all of the detected audio signals 12. Thus, the audio filter system 10 may build or otherwise design the audio filter 14 based on a position of an occupant speaker 106 within the vehicle 100.

Referring to FIGS. 1-3, the vehicle 100 is be equipped with a sensor array 102 configured to capture the audio signals 12 within the vehicle 100. The sensor array 102 may include, but is not limited to, a microphone array that captures the audio signals 12 and transmits the audio signals 12 to the audio filter system 10. The audio filter system 10 includes data processing hardware 16 and memory hardware 18 that is in communication with the data processing hardware 16. The data processing hardware 16 is configured to receive the audio signals 12. It is generally contemplated that the audio filter system 10 includes a computer-implemented method 20 that is executed by the data processing hardware 16 and causes the data processing hardware 16 to perform various operations, described herein, to design the audio filter 14. Additionally or alternatively, the memory hardware 18 may store the computer-implemented method 20 as an instruction that, when executed on the data processing hardware 16, causes the data processing hardware 16 to perform the operations described herein.

The audio filter system 10 may be configured as part of a vehicle computer or controller 104. For example, the sensor array 102 receives the audio signals 12 and transmits the audio signals 12 to the vehicle controller 104. The vehicle controller 104, in response to receiving the audio signals 12, may initiate the audio filter system 10. For example, the vehicle controller 104 may execute the computer-implemented method 20 of the audio filter system 10 to begin designing the audio filter 14. The audio filter 14 is configured to filter the audio signals 12 and identify a speaker. The speaker is typically an occupant 106 in the vehicle 100. It is contemplated that the audio filter system 10 may distinguish between multiple occupants 106 speaking at the same time using the computer-implemented method 20 described herein.

The audio filter system 10 utilizes the spatial audio zones Z₁-Z₄ to enhance clarity of the target speaker 106a. For example, the audio filter system 10 uses the interference audio signals 12b to identify the target speaker 106a. The interference audio signals 12b may then be utilized to design the audio filter 14 and enhance the target audio signal 12a. Ultimately, the interference audio signals 12b are attenuated by the designed audio filter 14 to further enhance the clarity of the target audio signal 12a. In some examples, the target speaker 106 may be a driver 106a of the vehicle 100, as mentioned below, The audio signals 12 are captured by the sensor array 102, and the audio filter system 10 determines the target audio signal 12a corresponding with the driver 106a. The audio signals 12 associated with a passenger 106b are thus interference audio signals 12b and are cancelled.

As mentioned above, the audio signals 12 may include one or more target audio signals 12a and one or more interference audio signals 12b. Ultimately, the audio filter system 10 is configured to attenuate the interference audio signals 12b and amplify or otherwise enhance the target audio signals 12a. The resultant signal is a filtered audio signal 12c containing minimal to no interference audio signals 12b. The filtered audio signal 12c may be communicated with a third-party processor that is in communication with the vehicle controller 104 and configured to receive the filtered audio signals 12c.

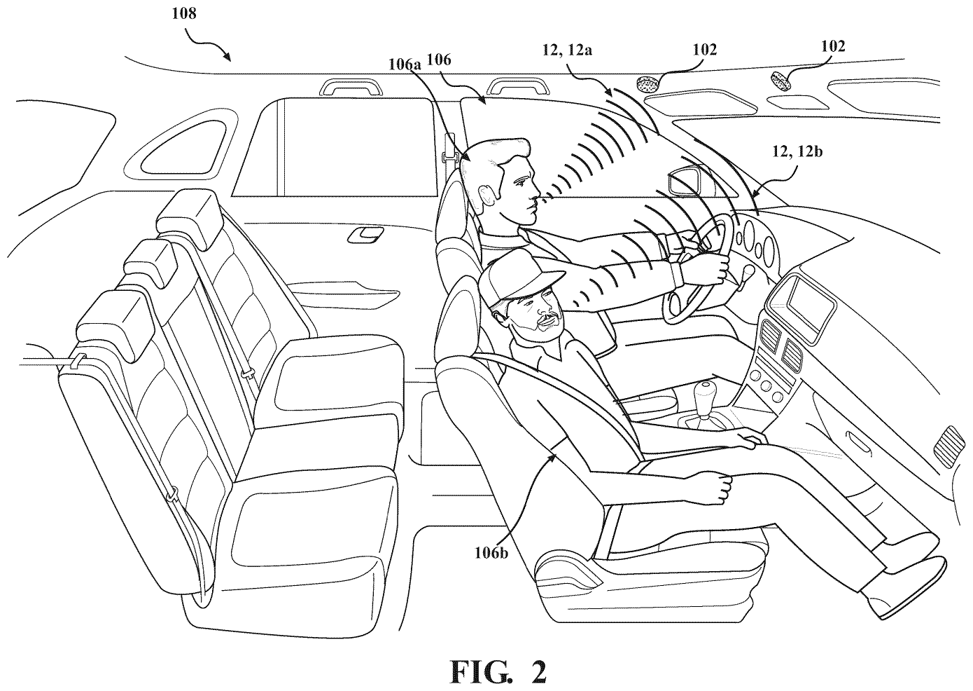

For example, FIG. 2 illustrates a first occupant 106a and a second occupant 106b simultaneously emitting audio signals 12 with the sensor array 102 disposed within an interior cabin 108 of the vehicle 100. In the illustrated example, the sensor array 102 is configured to receive each audio signal 12a, 12b from the respective occupants 106a, 106b, which are then transmitted to the audio filter system 10. While the sensor array 102 is illustrated as being at a forward portion of the interior cabin 108, it is contemplated that the sensor array 102 may be positioned at any practicable location within the interior cabin 108 to capture the audio signals 12. For example, the sensor array 102 may be positioned in locations including, but not limited to, a rearward portion, sideward portions, and a central portion.

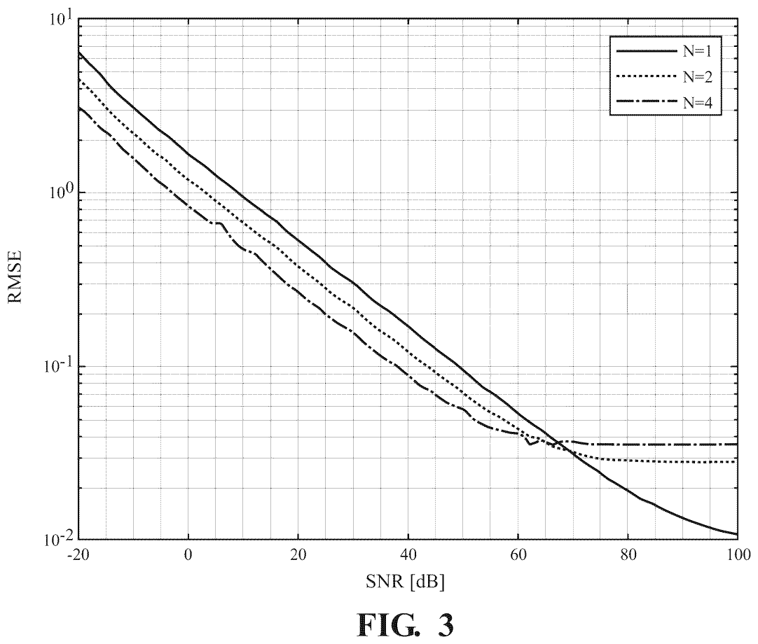

With reference now to FIGS. 3-6, FIG. 3 illustrates one example implementation of the audio filter system 10 and the improvement of the audio filter system 10 utilizing an increased number of interference audio signals 12b. For example, the number of interference audio signals 12b may increase based on a number of speakers (N) within the vehicle 100. The audio filter system 10 is configured to utilize each audio signal 12 detected by the sensor array 102 to tune the target audio signal 12a, such that a precision of the audio filter 14 is improved with multiple interference audio signals 12b. For example, the example graph illustrated in FIG. 3 illustrates a difference in performance of the audio filter 14 based on a single speaker, two speakers, and four speakers. If there is a single speaker in the vehicle 100, where N=1, the audio filter 14 may be designed based on a single target audio signal 12a. If there are two speakers in the vehicle 100, where N=2, the audio filter system 10 may have a reduced estimation error as a result of the comparison between the two audio signals 12. The audio filter system 10 may be further improved if there are four speakers in the vehicle, where N=4. Thus, the increased number of speakers may reduce the estimation error that may occur during design of the audio filter 14.

It is contemplated, however, that at a predefined number of speakers, the estimation error may begin to bias in an opposite direction, in a similar manner, as when there is a single speaker in high signal-to-noise ratio (SNR) levels. For example, the bias is a function of the SNR level and the predefined number of speakers. In some examples, the predefined number of speakers may be five speakers within the vehicle 100, but may, in other examples, be any natural predefined number of speakers. The audio filter system 10 is configured to exploit the non-target speakers in order to design an improved audio filter 14 to filter the interference audio signals 12b more efficiently to achieve the enhanced or filtered audio signal 12c. Stated differently, the interference audio signals 12b may be utilized in designing the audio filter 14. Each of the audio signals 12 is analyzed by the audio filter system 10 to estimate the target audio signal 12a and design the audio filter 14 for estimating the target audio signal 12a.

The presence of multiple interference audio signals 12b helps to enhance the target audio signal 12a based on speech quality and overall speech enhancement. A greater number of interference audio signals 12b may result in the audio filter system 10 having improved refinement when designing the audio filter 14. The improved refinement is a result of the increased opportunity of comparison of the interference audio signals 12b. The main task of the audio filter system 10 is to design the audio filter 14 to isolate the target audio signal 12a and attenuate all of the remaining interference audio signals 12b using beamforming methods followed by the audio filter 14, described herein. Once the audio filter 14 is designed, as described below, the audio filter 14 receives all of the audio signals 12 from within the vehicle 100 to estimate the filtered audio signal 12c at the output of the audio filter 14.

With further reference to FIGS. 3-6, the audio filter system 10 initiates designing the audio filter 14 upon receipt of the audio signals 12, including the target audio signal 12a and the interference audio signals 12b, from the sensor array 102. The audio filter system 10 estimates the target audio signal 12a from the received audio signals 12 and utilizes each of the audio signals 12, including the interference signals 12b, to design the audio filter 14, as described herein, to enhance the estimated target audio signal 12a. The audio signals 12, received by the audio filter system 10, are processed using a short-time Fourier transform (STFT) 30. STFT 30 is utilized to determine a timeframe index (n) and a frequency bin index (k) of each respective audio signal output 32, represented by (X) in FIG. 5B.

The respective audio signal outputs 32 may be specified for a specific timeframe index (n) and a corresponding specific frequency bin index (k). Each of the audio signals 12 may have various iterations 34 that may be represented by (Xᵢ). Like the respective audio signal outputs (X), each of the iterations 34 is dependent upon the timeframe index (n) and the frequency bin index (k). As used throughout, the subscript (i) may be utilized as a placeholder for a number associated with a respective speaker. For example, where there are four (4) speakers there may be four iterations 34, each represented as one of (X₁-X₄). However, it is contemplated that the number of iterations 34 is not limited to four, as each iteration 34 is based upon a respective speaker, which may be more than four speakers or less than four speakers.

Referring still to FIGS. 3-6, each iteration 34 of the audio signal outputs 32 may subsequently be passed through a set of beamformers 36 to generate a beamforming output 38 for each of the audio signal outputs 32, represented as (yᵢ). The beamforming outputs 38 may subsequently be utilized in combination with an estimated joint prior-signal-to-noise ratio (prior-SNR) 40, described below, to further define an output vector 42. For example, each output vector 42 may be identified using the following example equation, where the output vector 42 is represented by (of (n,k)):

$${σ}_{i}^{2} ( n k ) = α {σ}_{i}^{2} ( n - 1 , k ) + ( 1 - a ) max ( {\vert {y}_{i} ( n , k ) \vert}^{2} - {σ}_{{v}_{i}}^{2} ( n , k ) , 0 )$$

Further, the speech energy (Q) for the respective speaker may be determined using the respective linear equation for each of the generated output vectors from the beamformers 36. An example linear equation, which result in the speech energy (Q), includes:

$$Q = P {σ}^{2} ( n , k ) + d$$

Where [P]ᵢⱼ=|wᵢ^{H}ĥⱼ|², d=[σᵥ_{ᵢ}² . . . σᵥ_{_{N}}²]^{T}, σ²=[σᵢ² . . . σ_{N}²]^{T} and assuming that [P]ᵢᵢ≅1.

The output vectors 38, outlined in the above example equation, may be solved using, for example, [symbol] =(P^{T}P)⁻¹P^{T}Q. Using each of the generated output vectors 38, the estimated noise variance, and the extracted speech energy, the prior-signal-to-noise ratio (prior-SNR) 40 may be determined. The prior-SNR 40 at each of the output vectors 42 may be represented by the following example equation:

$$S N {R}_{i} ( n , k ) = \frac{{\hat{σ}}_{i}^{2} ( n , k )}{{σ}_{{v}_{i}}^{2} ( n , k )}$$

It is generally contemplated that the prior-SNR 40 is estimated as a joint prior-SNR 40. The joint prior-SNR 40 is a compilation of respective individual prior-SNR 40 for each of the audio signals 12. Each individual prior-SNR 40 may be calculated by dividing the speech energy (Q) by estimated noise variance (σᵥ_{ᵢ}). Each prior-SNR 40 represents a relation between a respective channel expressed in a matrix and the separately estimated noise variance (σᵥ_{ᵢ}).

With further reference to FIGS. 3-6, each prior-SNR 40 may be utilized to calculate a likelihood ratio (LRᵢ) of the audio filter 14. The likelihood ratio (LRᵢ) may be represented by the following example equation:

$$L {R}_{i} = \frac{S N {R}_{i}}{{max}_{k \neq i} {SNR}_{k}}$$

Each individual prior-SNR 40 may be separately utilized to determine a respective likelihood ratio (LRᵢ) for each speaker 106. As described herein, the audio filter system 10 is configured to identify a target speaker 106a (FIG. 2) and leverage the interference audio signals 12b to enhance the target audio signals 12a associated with the target speaker 106a. For example, the likelihood ratio (LRᵢ) associated with the target audio signal 12a may be utilized to execute a series of gain calculations 44 to obtain a set of gain values 44a. It is also contemplated that the likelihood ratio (LRᵢ) is calculated for each of the interference audio signals 12b as well, which may be leveraged by the audio filter system 10 to, ultimately, enhance the target audio signal 12a.

The gain calculations 44 are configured to represent the designed audio filter 14 to obtain the gain values 44a utilized to enhance the target audio signal 12a. The gain calculations 44 are achieved by the following example equation:

$${G}_{i} ( n , k ) = \frac{L {R}_{i}^{α}}{L {R}_{i}^{α} + 1}$$

Referring still to FIGS. 3-6, an example method of designing the audio filter 14 is described. At an initial step 300, the audio filter system 10 receives audio signals 12. The audio filter system 10, at 302, processes the audio signals 12 in the STFT 30 to obtain the audio signal outputs 32. The audio signal outputs 32, at 304, are passed through the beamformers 36, and the audio filter system 10, at 306, extracts the speech energy (Q) of each speaker. The audio filter system 10, at 308, determines the prior-SNR 40 for each of the beamforming outputs 38 and determines the likelihood ratio (LRᵢ), at 310. The audio filter system 10 subsequently, at 312, determines the gain value 28a, and ultimately, at 314, the audio filter system 10 enhances the target audio signal 12a based on the determined gain value 28a.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method executed by data processing hardware that causes the data processing hardware to perform operations to design an audio filter comprising:
receiving, from a sensor array, multiple audio signals including a target audio signal and interference audio signals;
processing the multiple audio signals using short-time Fourier transform (STFT);
generating an output vector for each of the multiple audio signals via a set of beamformers;
estimating a noise variance for each of the multiple audio signals;
extracting a speech energy for a respective speaker corresponding to each of the multiple audio signals using the generated output vector from the beamformers;
determining a prior-signal-to-noise ratio (prior-SNR) using the generated output vectors, the estimated noise variance, and the speech energy for each of the multiple audio signals; and
determining a gain value based on the prior-SNR.

2. The method of claim 1, further including enhancing the target audio signal using the designed audio filter and attenuating the interference audio signals.

3. The method of claim 1, wherein processing the multiple audio signals using STFT includes determining a timeframe index and a frequency bin index.

4. The method of claim 1, wherein generating the output vector for each of the multiple audio signals via the beamformers includes providing a number of speakers and generating dimensions for the output vector based on the provided number of speakers.

5. The method of claim 4, wherein determining the prior-SNR includes calculating an individual prior-SNR for each of the multiple audio signals and estimating the prior-SNR as a joint prior-SNR of each individual prior-SNR.

6. The method of claim 1, wherein estimating the noise variance for each of the multiple audio signals includes expressing each noise variance as a respective linear equation for each generated output vector from the beamformers.

7. The method of claim 6, wherein extracting the speech energy for the respective speaker includes determining the speech energy using the respective linear equation for each generated output vector from the beamformers.

8. An audio filter system for a vehicle, the audio filter system comprising:
data processing hardware; and
memory hardware in communication with the data processing hardware, the memory hardware storing instructions that when executed on the data processing hardware cause the data processing hardware to perform operations to design an audio filter comprising:
receiving multiple audio signals from a sensor array, the multiple audio signals including a target audio signal and interference audio signals;
leveraging the interference audio signals;
determining a prior-signal-to-noise ratio (prior-SNR) for each of the multiple audio signals;
designing the audio filter using the determined prior-SNR; and
enhancing the target audio signal using the leveraged interference audio signals and the designed audio filter by attenuating the interference audio signals using the designed audio filter.

9. The audio filter system of claim 8, further including processing the multiple audio signals using short-time Fourier transform (STFT) and generating an output vector for each of the multiple audio signals via a set of beamformers.

10. The audio filter system of claim 9, wherein processing the multiple audio signals using STFT includes determining a timeframe index and a frequency bin index.

11. The audio filter system of claim 9, wherein generating the output vector for each of the multiple audio signals via the beamformers includes providing a number of speakers and generating dimensions for the output vector based on the provided number of speakers.

12. The audio filter system of claim 11, wherein determining the prior-SNR includes calculating an individual prior-SNR for each of the multiple audio signals and estimating the prior-SNR as a joint prior-SNR of each individual prior-SNR.

13. The audio filter system of claim 11, further including estimating a noise variance for each of the generated output vectors from the beamformers and extracting a speech energy for a respective speaker corresponding to each of the multiple audio signals using a respective linear equation.

14. The audio filter system of claim 13, wherein estimating the noise variance includes estimating each noise variance individually at the respective linear equation of the generated output vector and extracting the speech energy for the respective speaker includes determining the speech energy using the respective linear equation for the generated output vector from the beamformers.

15. A computer-implemented method executed by data processing hardware that causes the data processing hardware to perform operations to design an audio filter comprising:
receiving multiple audio signals from a sensor array, the multiple audio signals including a target audio signal and interference audio signals;
leveraging the interference audio signals;
determining a prior-signal-to-noise ratio (prior-SNR) for each of the multiple audio signals;
designing the audio filter using the determined prior-SNR; and
enhancing the target audio signal using the leveraged interference audio signals and the designed audio filter and attenuating the interference audio signals.

16. The method of claim 15, further including processing the multiple audio signals using short-time Fourier transform (STFT) and generating an output vector for each of the multiple audio signals via a beamformers.

17. The method of claim 16, wherein processing the multiple audio signals using STFT includes determining a timeframe index and a frequency bin index.

18. The method of claim 16, wherein generating the output vector for each of the multiple audio signals via the beamformers includes providing a number of speakers and generating dimensions for the output vector based on the identified number of speakers.

19. The method of claim 18, wherein determining the prior-SNR includes calculating an individual prior-SNR for each of the multiple audio signals and estimating the prior-SNR as a joint prior-SNR of each individual prior-SNR.

20. The method of claim 18, further including estimating a noise variance for each of the multiple audio signals and extracting a speech energy for a respective speaker corresponding to each of the multiple audio signals using a respective linear equation for each generated output vector, wherein estimating the noise variance includes estimating each noise variance by the respective linear equation and extracting the speech energy for the respective speaker includes determining the speech energy using the respective linear equation for each generated output vector from the beamformers.
